(19) United States
(12) Patent Application Publication
(10) Pub. No.: US 2010/0174705 A1
(43) Pub. Date: Jul. 8, 2010

(54) STAY LOCATION CONNECTION INFORMATION REGISTER DEVICE, STAY LOCATION CONNECTION INFORMATION REGISTER METHOD, STAY LOCATION CONNECTION INFORMATION REGISTER PROGRAM AND STORAGE MEDIUM

(75) Inventor: Yasufumi Iwahori, Tokyo (JP)

Correspondence Address: YOUNG & THOMPSON, 209 Madison Street, Suite 500, Alexandria, VA, 22314, US

(73) Assignees: PIONEER CORPORATION, TOKYO (JP); INCREMENT P CORPORATION, TOKYO (JP)

(21) Appl. No.: 12/298,097

(22) PCT Filed: Jul. 17, 2007
(86) PCT No.: PCT/JP2007/064102

§ 371 Date: Oct. 22, 2008

(51) Int. Cl. G06F 17/30

(52) U.S. Cl. 707/723; 707/769; 707/812; 707/E17.014; 707/E17.017

(57) ABSTRACT

A stay location connection information register device retains history information including user information and stay location information. A history information searching unit searches history information coincident with a predetermined condition. A stay location connection information generating unit generates link information of the stay location by the unit of the user information with using the history information searched by the history information searching unit. Then, the stay location connection information register unit registers the stay location connection information. In this manner, since the stay location connection information register device generates the link information of the stay location with using the history information, the stay location connection information register device can define a correspondent relation between the stay locations. Therefore, the stay location connection information register device can supply the search result based on the association between the stay locations with using the above link information.

### TECHNICAL FIELD

The present invention relates to a technique of registering stay location connection information for supplying useful information to a device which requests searching.

### BACKGROUND TECHNIQUE

Conventionally, there are known various kinds of methods of retaining movement history information including positional information of a movable body in advance and using the movement history information. Concretely, there is a navigation device which indicates a route including many points of the above movement history information at the time of searching the route (see Patent Reference-1, for example).

Patent Reference-1: Japanese Patent Application Laid-open under No. 2000-46576

### DISCLOSURE OF INVENTION

### Problem to be Solved by the Invention

However, the above-mentioned navigation device only searches and uses the movement history information. Therefore, there is such a problem that the movement history information is not always used efficiently.

The present invention has been achieved in order to solve the above problem. It is an object of this invention to provide a stay location connection information register device for more effectively using the movement history information.

### Means for Solving the Problem

In the present invention according to claim 1, there is provided a stay location connection information register device, including: a history information retaining unit which includes user information and stay location information; a history information searching unit which searches the history information; a stay location connection information generating unit which generates stay location connection information including link information of the stay location by a unit of the user information with using the history information searched by the history information searching unit; and a stay location connection information register unit which registers the stay location connection information.

In the present invention according to claim 7, there is provided a stay location connection information register method, including: a history information retaining process which includes user information and stay location information; a history information searching process which searches the history information; a stay location connection information generating process which generates stay location connection information including link information of the stay location by a unit of the user information with using the history information searched by the history information searching process; and a stay location connection information register process which registers the stay location connection information.

In the present invention according to claim 8, there is provided a stay location connection information register program executed by a device including a computer, making the computer function as: a history information retaining unit which includes user information and stay location information; a history information searching unit which searches the history information; a stay location connection information generating unit which generates stay location connection information including link information of the stay location by a unit of the user information with using the history information searched by the history information searching unit; and a stay location connection information register unit which registers the stay location connection information,

### BRIEF DESCRIPTION OF THE DRAWINGS

FIG. 1 is a diagram schematically showing a configuration of an information supplying system;

FIG. 2 is a conceptual diagram of a navigation device;

FIG. 3 is a block diagram schematically showing a configuration of a stay location connection information register server;

FIGS. 4A to 4D are conceptual diagrams of various kinds of data structures;

FIG. 5A to 5C are conceptual diagrams of various kinds of data structures;

FIGS. 6A and 6B are diagrams showing examples of specifying stay information;

FIG. 7 is a flow chart of a stay area history information register process;

FIG. 8 is a diagram showing an example of the stay area history information;

FIG. 9 is a conceptual diagram showing an example of stay location connection information;

FIG. 10 is a flow chart of the stay location connection information register process; and

FIG. 11 is a flow chart of a recommendation information supplying process.

### BRIEF DESCRIPTION OF THE REFERENCE NUMBER

1 Information supplying system
300 Current position information supplying device
350 Facility information DB
360 Category DB
370 Stay area history information DB
380 Preference category information DB
400 Stay location connection information register server
416 Stay area history information searching unit
417 Stay location connection information generating unit
418 Stay location connection information register unit
419 Stay location connection information searching unit
420 Information supply request receiving unit
421 Recommendation information generating unit
422 Recommendation information supplying unit
500 Information supply requesting device
510 Link information DB
520 Facility stay number information DB
530 Link connection number information DB

### DETAILED DESCRIPTION OF THE PREFERRED EMBODIMENTS

According to one aspect of the present invention, there is provided a stay location connection information register device, including: a history information retaining unit which includes user information and stay location information; a history information searching unit which searches the history information; a stay location connection information generating unit which generates stay location connection information including link information of the stay location by a unit of the user information with using the history information searched by the history information searching unit; and a stay location connection information register unit which registers the stay location connection information.

Concretely, the above stay location connection information register device may be formed as a server device. The stay location connection information register device retains the history information including the user information and the stay location information. The history information searching unit searches the history information coincident with the predetermined condition. The stay location connection information generating unit generates the link information of the stay location by the unit of the user information with using the history information searched by the history information searching unit. The link means a pair of stay locations corresponding to the same user information, and the link information is information relating to the above-mentioned link. In addition, the stay location connection information is information including the above-mentioned link information. The stay location connection information register unit registers the above stay location connection information.

As described above, since the stay location connection information register device generates the link information of the stay location with using the history information and registers the link information, the stay location connection information register device can define the correspondent relation between the stay locations. Thus, the stay location connection information register device can supply a search result based on the relation between the stay locations with using the above-mentioned link information.

In a manner of the above stay location connection information register device, the stay location connection information generating unit may generate link weight information with using the history information retaining unit, and may associate the link weight information with the link information. The link weight information indicates the number of same links. As described above, the stay location connection information register device can define dominance between the links by associating the link weight information with the link information.

In another manner, the stay location connection information register device may further include a category information retaining unit which retains category information, and may generate the stay location connection information for each category. In this case, the stay location connection information register device can generate the stay location connection information for each category. Therefore, the stay location connection information register device can define the correspondent relation between the stay locations by the unit of category.

In still another manner of the above stay location connection information register device, the stay location connection information generating unit may generate stay number information of the stay location, and may include the stay number information in stay location connection information. In this case, the stay location connection information register device can use the above stay number as a material for determining dominance of the stay location of the link with using the above stay number information.

In still another manner of the above stay location connection information register device, the stay location connection information generating unit may generate link connection number information of the stay location, and may include the link connection number information in stay location connection information. In this case, the stay location connection information register device can define the dominance between the links.

In still another manner, the above stay location connection information register device may further include: a recommendation information supply request receiving unit which receives recommendation information supply request with user information of an information supply requesting device; a stay location connection information searching unit which searches the stay location connection information; a recommendation information generating unit which generates recommendation information with using the history information corresponding to the user information of the information supply requesting device and the stay location connection information; and a recommendation information supplying unit which supplies the recommendation information to the information supply requesting device. The recommendation information is information including the information useful to the user of the information supply requesting device in priority. Since the stay location connection information register device generates the recommendation information with using the history information corresponding to the user information of the information supply requesting device and the stay location connection information and transmits the recommendation information to the information supply requesting device, the stay location connection information register device can supply the information more useful to the user of the information supply requesting device than before.

According to another aspect of the present invention, there is provided a stay location connection information register method, including: a history information retaining process which includes user information and stay location information; a history information searching process which searches the history information; a stay location connection information generating process which generates stay location connection information including link information of the stay location by a unit of the user information with using the history information searched by the history information searching process; and a stay location connection information register process which registers the stay location connection information.

By the method, since the link information of the stay location is generated with using the history information and the link information is registered, the correspondent relation between the stay locations can be defined.

According to still another aspect of the present invention, there is provided a stay location connection information register program executed by a device including a computer, making the computer function as: a history information retaining unit which includes user information and stay location information; a history information searching unit which searches the history information; a stay location connection information generating unit which generates stay location connection information including link information of the stay location by a unit of the user information with using the history information searched by the history information searching unit; and a stay location connection information register unit which registers the stay location connection information.

By executing the program in various kinds of devices, the stay location connection information register device according to the present invention can be realized. The stay location connection information register program can be preferably treated in a state of being recorded on a recording medium.

### Embodiment

The preferred embodiment of the present invention will now be described below with reference to the attached drawings.

### [Schematic Configuration of Information Supplying System]

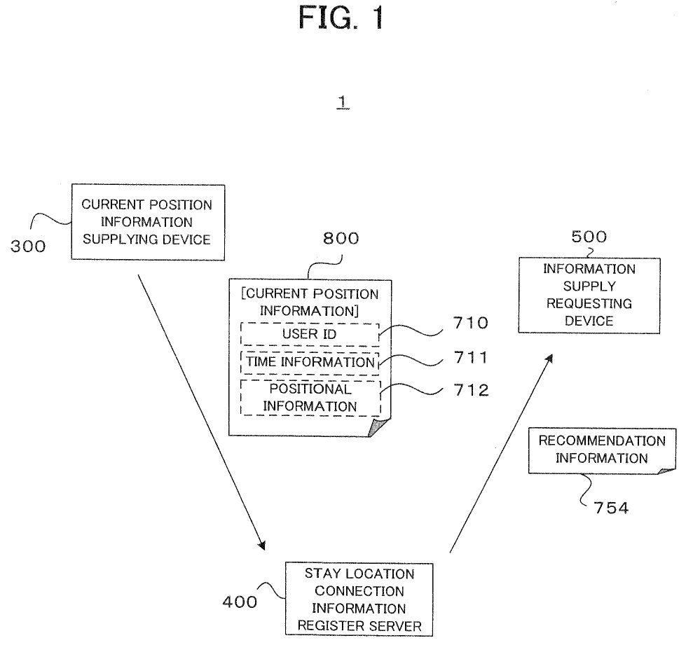

FIG. 1 schematically shows a configuration of an information supplying system 1. In this embodiment, the information supplying system 1 includes a current position information supplying device 300, a stay location connection information register server 400 and an information supply requesting device 500.

Concretely, the current position information supplying device 300 is a navigation device 200 (described in details later) including a GPS (Global Positioning System) receiver. The current position information supplying device 300 suitably transmits a current position information 800 to the stay location connection information register server 400, and transmits the current position information 800 at one time. The current position information 800 is information including positional information 712 obtained via the GPS receiver, time information 711 at the time of obtaining the positional information 712 and a user ID 710 for identifying the current position information supplying device 300. The current position information supplying device 300 obtains the positional information 712 and transmits the current position information 800 in correspondence with a position measurement interval and a transmission interval defined by a parameter file retained in a data storage unit 36 in the navigation device 200.

The stay location connection information register server 400 is a server device, which specifies the period and facility in which the current position information supplying device 300 stays on the basis of the current position information 800 obtained from the current position information supplying device 300 to retain the specified information as stay area history information 375. Then, the stay location connection information register server 400 generates link information 515 for defining association between the above stay facilities by using the above stay area history information 375, and registers the link information 515. The stay location connection information register server 400 will be described in details, later.

Concretely, the information supply requesting device 500 is a personal computer or an on-vehicle navigation device. When the information supply requesting device 500 requests the information supply to the stay location connection information register server 400, the stay location connection information register server 400 transmits recommendation information 754 generated based on the retained link information 515. The recommendation information 754 is information including information useful to the information supply requesting device 500 in priority.

As described above, in the information supplying system 1, the stay location connection information register server 400 specifies the stay facility with using the current position information 800 obtained from the current position information supplying device 300, and registers the stay area history information 375 including the information (e.g., the name of facility) of the stay facility. Then, in response to the information supply request from the information supply requesting device 500, the stay location connection information register server 400 supplies, to the information supply requesting device 500, the recommendation information 754 based on the stay area history information 375. The stay location connection information register server 400 automatically specifies the facility at which the current position information supplying device 300 stays with using the current position information 800 obtained from each of the current position information supplying devices 300, which makes it unnecessary for the user of the current position information supplying device 300 to input the positional information of the used facility.

Now, a description will be given of an example of a navigation device loaded on the current position information supplying device 300.

### [Navigation Device]

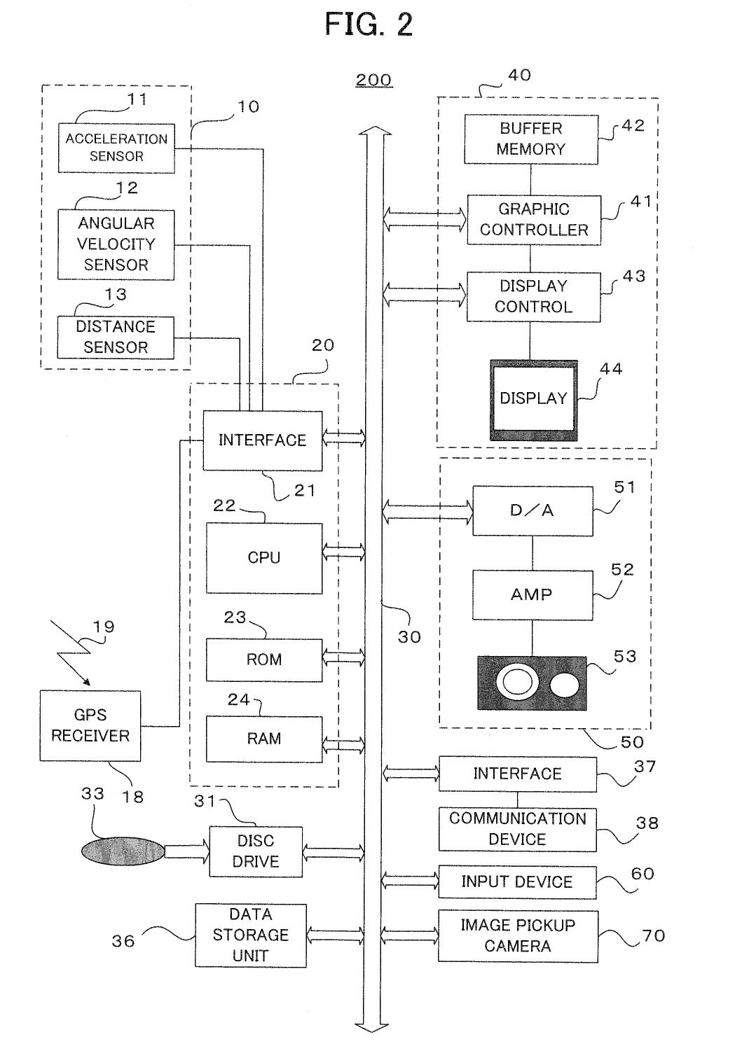

FIG. 2 shows a configuration of the navigation device 200 according to an embodiment of the present invention. As shown in FIG. 2, the navigation device 200 includes a stand-alone position measurement device 10, a GPS receiver 18, a system controller 20, a disc drive 31, a data storage unit 36, a communication interface 37, a communication device 38, a display unit 40, a sound output unit 50 and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures a vehicle speed pulse including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation device 200.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected with each other via a bus line 30.

Under the control of the system controller 20, the disc drive 31 reads contents data such as sound data and picture data from the disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map information and facility data.

The communication device 38 includes an FM tuner, a beacon receiver, a mobile phone and a dedicated communication card, for example, and receives various kinds of information via the communication interface 37.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 for temporarily storing image information having a memory such as a VRAM (Video RAM) and immediately displayable, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data transmitted from the disc drive 31 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of a front panel of a main body and the display 44 of an on-vehicle electric system loaded on the vehicle. Additionally, in such a case that the display 44 is of a touch panel system, a touch panel provided on the display screen of the display 44 functions as the input device 60, too.

### [Stay Location Connection Information Register Server]

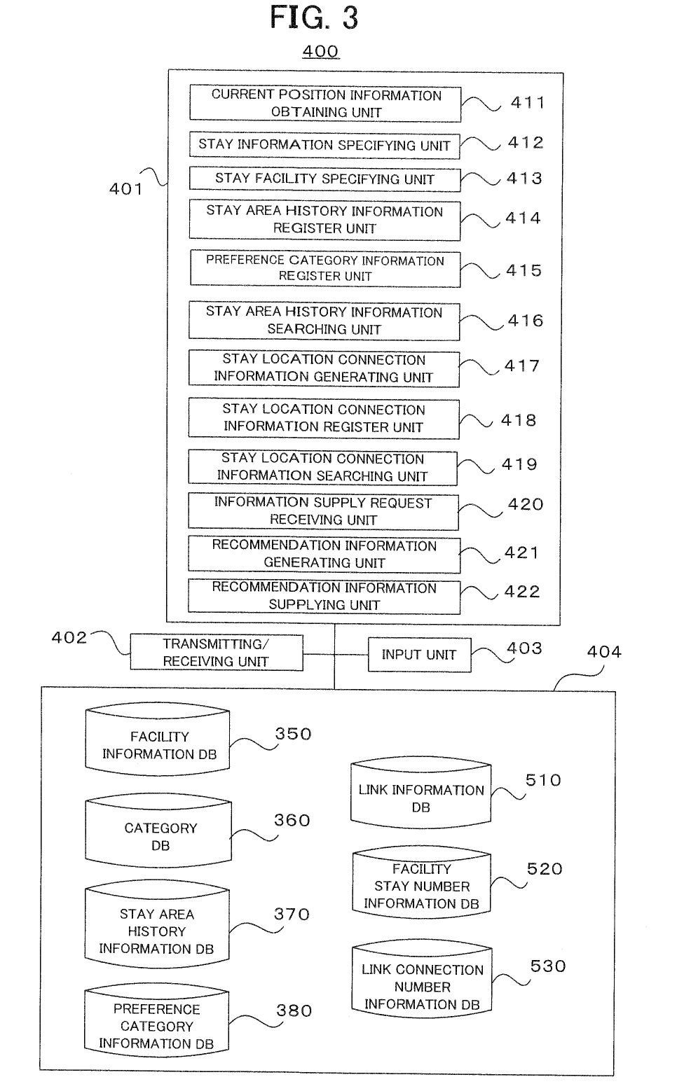

FIG. 3 shows a functional configuration of the stay location connection information register server 400. The stay location connection information register server 400 is actually a server device. As shown in FIG. 3, the stay location connection information register server 400 includes a control unit 401, a transmitting/receiving unit 402, an input unit 403 and a storage unit 404. The storage unit 404 includes a facility information DB 350, a category DB 360, a stay area history information DB 370, a preference category information DB 380, a link information DB 510, a facility stay number information DB 520 and a link connection number information DB 530. The control unit 401 is concretely a CPU, and entirely controls the stay location connection information register server 400. The control unit 401 includes a current position information obtaining unit 411, a stay information specifying unit 412, a stay facility specifying unit 413, a stay area history information register unit 414, a preference category information register unit 415, a stay area history information searching unit 416, a stay location connection information generating unit 417, a stay location connection information register unit 418, a stay location connection information searching unit 419, an information supply request receiving unit 420, a recommendation information generating unit 421 and a recommendation information supplying unit 422. Namely, the control unit 401 executes a predetermined program, which realizes the current position information obtaining unit 411, the stay information specifying unit 412, the stay facility specifying unit 413, the stay area history information register unit 414, the preference category information register unit 415, the stay area history information searching unit 416, the stay location connection information generating unit 417, the stay location connection information register unit 418, the stay location connection information searching unit 419, the information supply request receiving unit 420, the recommendation information generating unit 421 and the recommendation information supplying unit 422.

The transmitting/receiving unit 402 transmits and receives various kinds of information such as the current position information 800 and the recommendation information 754. Concretely, the transmitting/receiving unit 402 is a network interface. The input unit 403 is formed by a keyboard and a mouse for inputting various kinds of commands and data. The storage unit 404 retains the facility information DB 350, the category DB 360, the stay area history information DB 370, the preference category information DB 380, the link information DB 510, the facility stay number information DB 520 and the link connection number information DB 530. Concretely, the storage unit 404 is a hard disc. The facility information DB 350 is a database which retains the facility information 355 associated with the position and name of the facility.

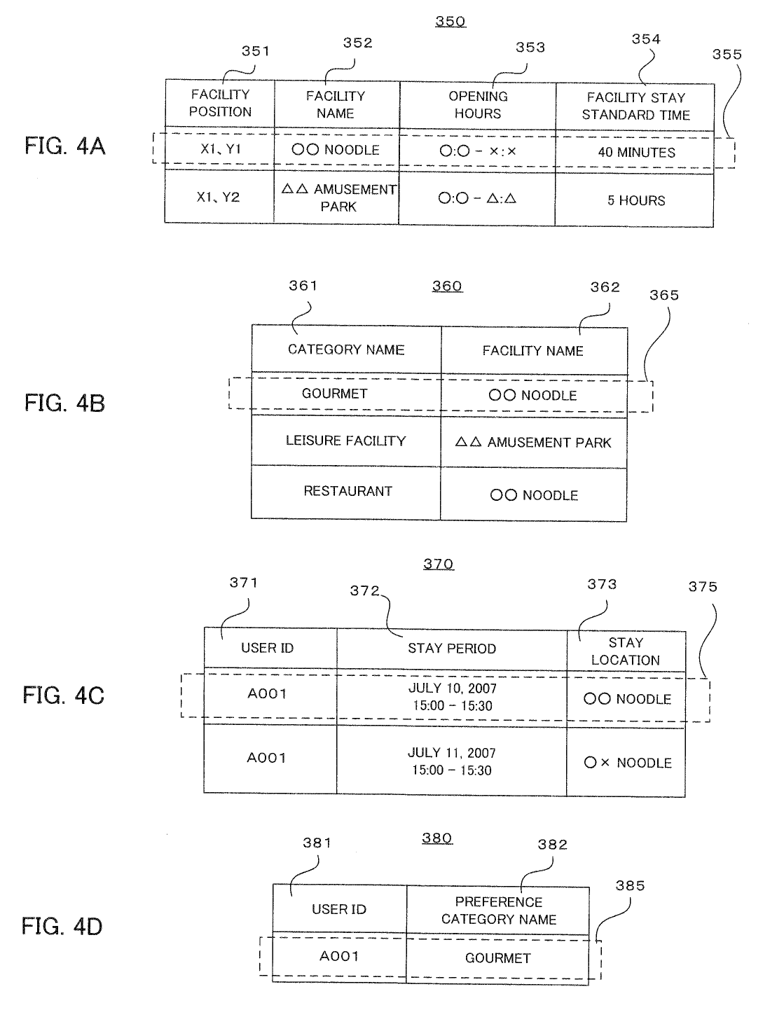

FIG. 4A shows an example of the facility information DB 350. As shown, the facility information DB 350 includes a facility position 351 showing the location information of the facility, a facility name 352 showing the facility name, an opening hours 353 showing the opening hours of the facility, and a facility stay standard time 354 showing the standard time of staying at the facility.

The category DB 360 is a database for retaining category information 365. FIG. 4B shows an example of the category DB 360. The category information 365 includes a category name 361 showing the category of the facility and a facility name 362 showing the name of the facility.

The stay area history information DB 370 is a database for retaining the stay area history information 375. FIG. 4C shows an example of the stay area history information DB 370. The stay area history information 375 includes a user ID 371 showing the user ID of the current position information supplying device 300, a stay period 372 showing the staying period of the facility, and a stay location 373 showing the stay location.

The preference category information DB 380 retains the category preferred by the user from the stay area history information 375 of the stay area history information DB 370, FIG. 4D shows an example of the preference category information DB 380. Concretely, the preference category information DB 380 retains preference category information 385 including a user ID 381 and a preference category name 382.

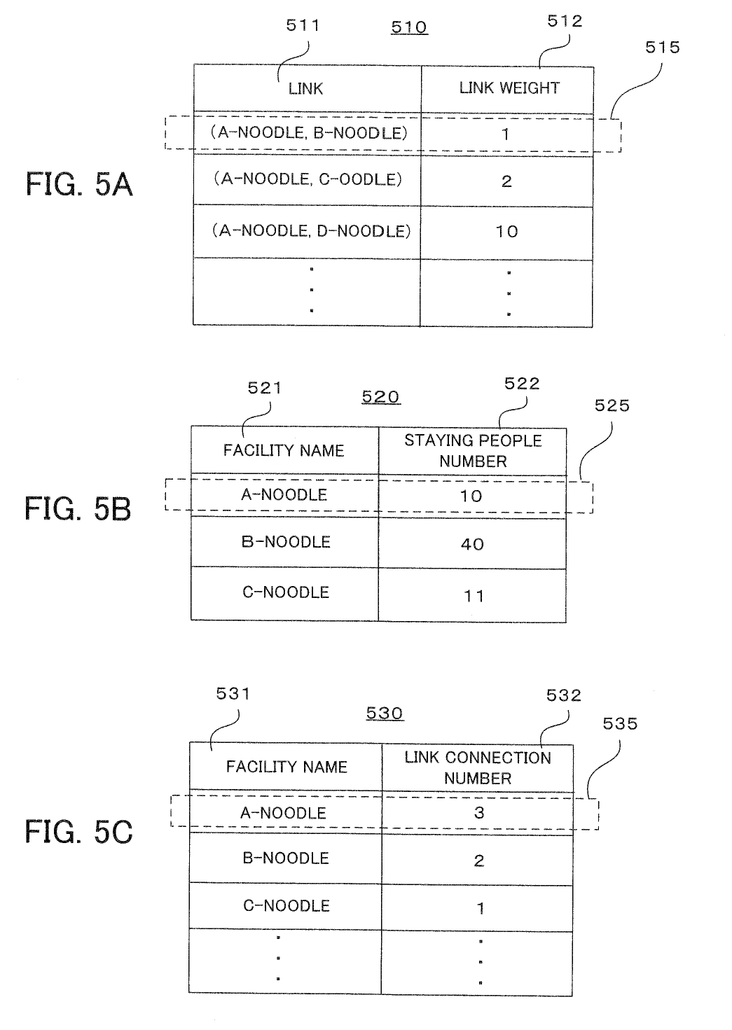

The link information DB 510 is a database for retaining the link information 515 including the link and the link weight information associated with each other. FIG. 5A shows an example of the link information DB 510. The link information 515 includes a link 511 and a link weight 512.

The link is a pair of stay locations corresponding to the same user information, and the link weight information is the number of same links.

The facility stay number information DB 520 is a database for retaining the facility stay number information 525. FIG. 5B shows an example of the facility stay number information DB 520. The facility stay number information 525 includes a facility name 521 and a staying people number 522.

The link connection number information DB 530 is a database for retaining link connection number information 535. FIG. 5C shows an example of the link connection number information DB 530. The link connection number information 535 includes a facility name 531 and a link connection number 532.

In addition, a set including the link information 515, the facility stay number information 525 and the link connection number information 535 is also referred to as “stay location connection information”.

The current position information obtaining unit 411 obtains the current position information 800 from the current position information supplying device 300. The current position information obtaining unit 411 stores the above current position information 800 in the storage unit 404.

The stay information specifying unit 412 specifies the stay information of the current position information supplying device 300 with using the current position information 800 obtained by the current position information obtaining unit 411. The stay information is information including the stay position 720 and the stay period 730. Specifically, when the current position information supplying device 300 is determined to be positioned at the same position for a predetermined period (e.g., 1 hour) as a result of arranging the obtained current position information 800 in the order of time information by the unit of user ID 710, the stay information specifying unit 412 prescribes that the current position information supplying device 300 stays at the position during the above period.

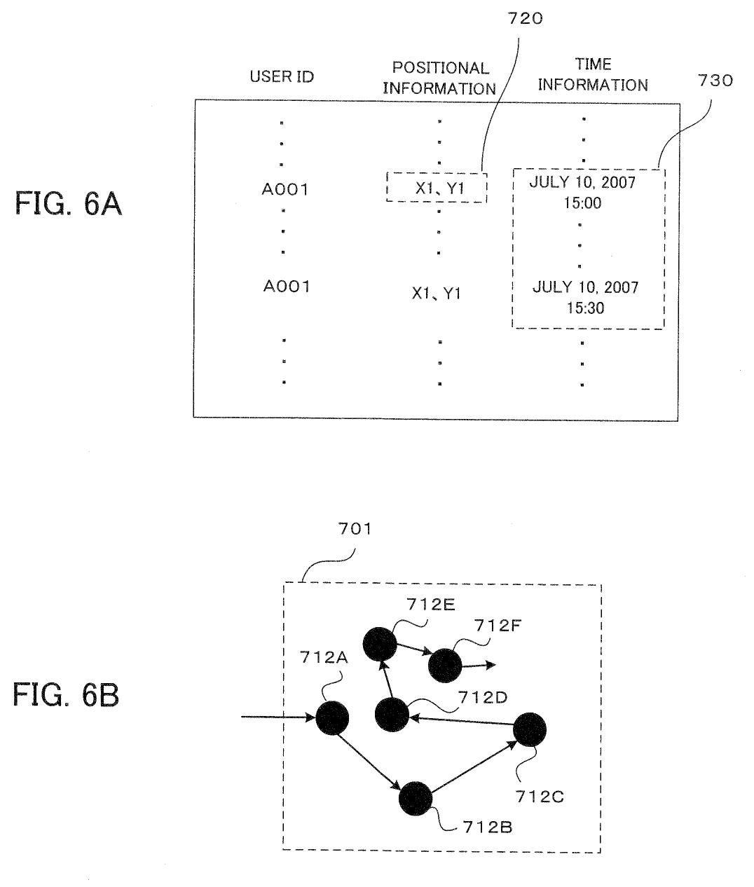

FIG. 6A shows an example of arranging the current position information 800 in the order of time information by the unit of user ID 710. In this case, the stay information specifying unit 412 determines that the current position information supplying device 300 corresponding to “A001” of the user ID 710 stays at a position “X1,Y1” “from 15:00 on Jul. 10, 2007 to 15:30 on Jul. 10, 2007”. Therefore, the stay information specifying unit 412 prescribes the stay position 720 as “X1, Y1”, and prescribes the stay period 730 as “15:00 on Jul. 10, 2007 to 15:30 on Jul. 10, 2007”.

Additionally, when the current position information supplying device 300 is positioned within a predetermined range in a predetermined period (hereinafter, this state is also referred to as “migration”), the stay information specifying unit 412 determines that the current position information supplying device 300 stays within the range in the above-mentioned period.

FIG. 6B shows an example of a migration state. As shown in FIG. 6B, when the positional information 712 of the current position information 800 is included in an area 701 in the predetermined period, the stay information specifying unit 412 prescribes the above-mentioned period as the stay period 730, and prescribes the stay position 720 of the current position information supplying device 300 as a predetermined position in the above-mentioned area 701.

The stay facility specifying unit 413 specifies the stay facility with using the stay position 720 specified by the above stay information specifying unit 412. Concretely, the stay facility specifying unit 413 searches the facility information DB 350. When the stay position 720 is within the predetermined range of the facility position 351 in the facility information 355 in the facility information DB 350, the stay facility specifying unit 413 determines that the current position information supplying device 300 stays at the facility corresponding to the facility position 351. Even when the stay position 720 is within the predetermined range of the facility position 351, in such a case that “the stay period 730 is not within the opening hours 353” and in such a case that “the stay time calculated based on the stay period 730 is largely different from the facility stay standard time 354”, the stay facility specifying unit 413 does not determine that the current position information supplying device 300 stays at the facility corresponding to the facility position 351. When the stay facility specifying unit 413 does not determine that the current position information supplying device 300 stays at the facility corresponding to the facility position 351 because “the stay period 730 is not within the opening hours 353”, the stay facility specifying unit 413 searches the facility information 355 other than the searched information including the stay position 720 within the predetermined range of the facility position 351, again. Then, when the stay period 730 is within the opening hours 353 of the facility information 355 searched again and the stay time calculated based on the stay period 730 is not largely different from the facility stay standard time 354, the stay facility specifying unit 413 determines that the current position information supplying device 300 stays at the facility corresponding to the facility information 355 searched again.

The stay area history information register unit 414 registers, to the stay area history information DB 370, the stay area history information 375 including the information such as the facility specified by the above stay facility specifying unit 413 and the stay time.

The preference category information register unit 415 obtains the stay area history information 375 from the stay area history information DB 370, and registers the preference category information 385 for each user.

Concretely, first, the preference category information register unit 415 obtains the stay area history information 375 from the stay area history information DB 370, and groups the obtained stay area history information 375 for each user ID 371.

Then, the preference category information register unit 415 determines the preference category having the large number of staying with using the stay area history information 375 and the category information 365 in the category DB 360 for each grouped user ID 371. For example, when the stay area history information 375 including the category “gourmet” corresponding to the stay location 373 is equal to or larger than the predetermined number as to the stay area history information 375 of the same user ID 371, the preference category information register unit 415 determines the preference category of the user ID 371 as “gourmet”.

The preference category information register unit 415 generates the preference category information 385 prescribing the user ID 371 having the preference category as the user ID 381 and prescribing the determined preference category as the preference category name 382 to register the preference category information 385 to the preference category information DB 380.

The stay area history information searching unit 416 accesses the stay area history information DB 370, and searches the above stay area history information 375 coincident with a predetermined condition. The stay location connection information generating unit 417 generates the state location connection information with using the stay area history information 375 searched by the above stay area history information searching unit 416. The concrete generating method will be described later.

The stay location connection information register unit 418 registers the stay location connection information generated by the stay location connection information generating unit 417. Concretely, the stay location connection information register unit 418 registers the link information 515 to the link information DB 510, and registers the facility stay number information 525 to the facility stay number information DB 520. Further, the stay location connection information register unit 418 registers the link connection number information 535 to the link connection number information DB 530.

The stay location connection information searching unit 419 searches the stay location connection information. Concretely, the stay location connection information searching unit 419 obtains the link information 515 coincident with a predetermined condition from the link information DB 510, and obtains the facility stay number information 525 coincident with a predetermined condition from the facility stay number information DB 520. Further, the stay location connection information searching unit 419 obtains the link connection number information 535 coincident with a predetermined condition from the link connection number information DB 530.

The information supply request receiving unit 420 obtains the user ID 710 of the information supply requesting device 500 from the information supply requesting device 500, and receives the recommendation information supply request.

The recommendation information generating unit 421 generates the recommendation information 475 with using the stay area history information 375 of the user ID 710 obtained from the information supply requesting device 500 and the stay location connection information. The detailed recommendation information generating method will be explained later.

The recommendation information supplying unit 422 supplies the recommendation information 475 generated by the recommendation information generating unit 421 to the information supply requesting device 500 which requests the information supplying via the transmitting/receiving unit 402.

In the embodiment having the above-mentioned configuration, it is realized that the facility information DB 350 functions as the facility information retaining unit, the stay facility specifying unit 412 functions as the stay area specifying unit, the opening hours 353 and the facility stay standard time 354 function as the stay determination information, and the stay area history information 375 functions as the history information.

### [Stay Area History Information Register Process]

Next, a description will be given of a stay area history information register process according to this embodiment. The stay area history information register process described in this embodiment is the process which specifies the facility and the stay period in which the current position information supplying device 300 stays based on the current position information 800 obtained from the current position information supplying device 300 to register the stay area history information including the stay facility and the stay period.

First, when the current position information 800 is transmitted from the current position information supplying device 300, the current position information obtaining unit 411 obtains the current position information 800, and retains the current position information 800 in the storage unit 404. Then, when the stay location connection information register server 400 detects a history information register order in correspondence with the operation of the user to the input unit 403, the stay information specifying unit 412 groups the current position information 800 by the unit of the user ID 710. Then, the stay information specifying unit 412 refers to the current position information 800 arranged in the order of the time information 711, and determines the stop state or the migration state to specify the stay information.

Then, the stay facility specifying unit 413 searches the facility information 355 including the stay position 720 within a predetermined range from the facility position 351 of the facility information DB 350. When such a condition (hereinafter also referred to as “stay area determination condition”) that, “within the range of the opening hours 353 of the facility information 355 searched by the stay period 730, and the stay time calculated based on the stay period 730 is not largely different from the facility stay time standard time 354 of the searched facility information 355” is satisfied, the stay facility specifying unit 413 prescribes the facility corresponding to the searched facility information 355 as the stay facility. In such a case that the above-mentioned stay area determination condition is not satisfied, the stay facility specifying unit 413 searches the facility information 355 other than the searched information including the stay position 720 within the predetermined range of the facility position 351 again. If the above-mentioned condition is satisfied, the stay facility specifying unit 413 prescribes the facility corresponding to the facility information 355 searched again as the stay facility.

Then, the stay area history information register unit 414 registers the stay area history information 375 to the DB 370. It is prescribed that the user ID 371 of the stay area history information 375 is the user ID 710 of the present facility information 800; the stay period 372 of the stay area history information 375 is the stay period 730 specified by the stay information specifying unit 412; and the stay location 373 of the stay area history information 375 is the stay facility specified by the stay facility specifying unit 413.

In this manner, the stay location connection information register server 400 obtains the current position information 800 including the positional information 712 and the time information 711, and specifies the stay position 720 and the stay time 730 with using the current position information 800. Thus, unlike the conventional system, it becomes possible to specify the stay position even if the device is not in the stop state. Therefore, unlike the navigation device which determines the stay position by detecting the stop state, the stay location connection information register server 400 can specify the stay position even under the condition that the stay position may move, like the case that PDA (Personal Digital Assistants) including the GPS receiver is applied to the current position information supplying device 300.

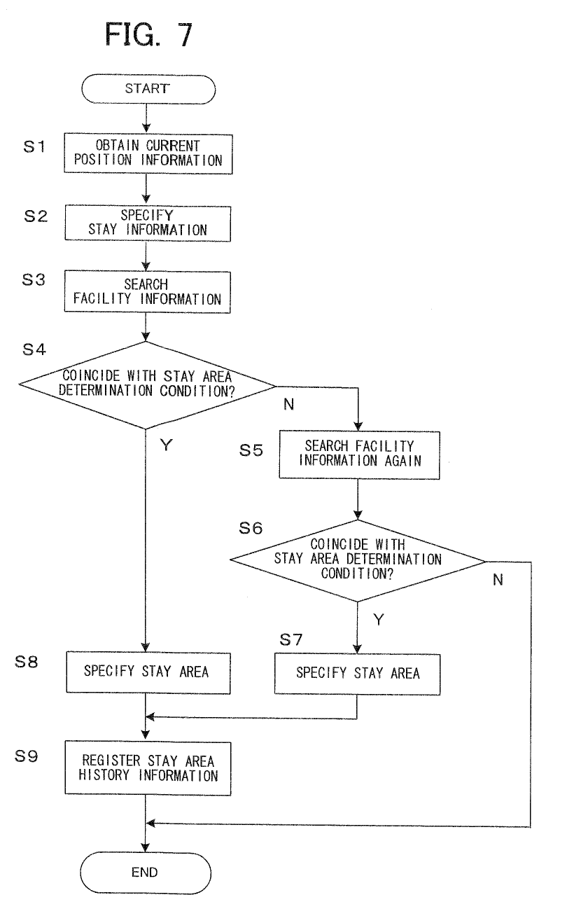

A procedure of the stay area history information register process will be explained with reference to a flow chart shown in FIG. 7, hereinafter. This process is realized in such a manner that the control unit 401 in the stay location connection information register server 400 executes a predetermined program.

First, the current position information obtaining unit 411 obtains the current position information 800 from the current position information supplying device 300 (step S1). Then, the stay information specifying unit 412 specifies the stay position 720 in the stop state or the migration state with using the current position information 800 obtained by the current position information obtaining unit 411, and specifies the stay time 730 (step S2).

Next, the stay facility specifying unit 413 searches the facility information 355 including the stay position 720 within the predetermined range from the facility position 351 of the facility information 355 retained by the facility information DB 350 (step S3).

Then, when the searched facility information 355 satisfies the stay area determination condition (step S4; Yes), the stay facility specifying unit 413 specifies the facility corresponding to the searched facility information 355 as the stay facility (step S8), and the process goes to step S9.

In addition, when the searched facility information 355 does not satisfy the stay area determination condition (step S4; No), the stay facility specifying unit 413 searches the facility information 355 which includes the stay position 720 within the predetermined range from the facility position of the facility information 355 and which is other than the facility information 355 searched at the first time (step S5), and determines whether or not the searched facility information 355 coincides with the above stay area determination condition. When the searched facility information 355 coincides with the above stay area determination condition (step S6; Yes), the stay facility specifying unit 413 specifies the facility corresponding to the facility information 355 searched again as the stay facility (step S7), and the process goes to step S9. When the searched facility information 355 does not coincide with the above stay area determination condition (step S6; No), the stay facility specifying unit 413 ends the stay area history information register process.

The stay area history information register unit 414 registers, to the stay area history information DB 370, the stay area history information 375 including the name of the stay facility specified by the stay facility specifying unit 413 and the stay period 730 (step S9), and ends the stay area history information registering.

### [Stay Location Connection Information Register Process]

Next, a description will be given of a stay location connection information register process according to this embodiment. The stay location connection information register process in this embodiment is a process which registers the stay location connection information with using the stay area history information 375. Now, an example of generating the link information 515 will be explained as to the category “gourmet”.

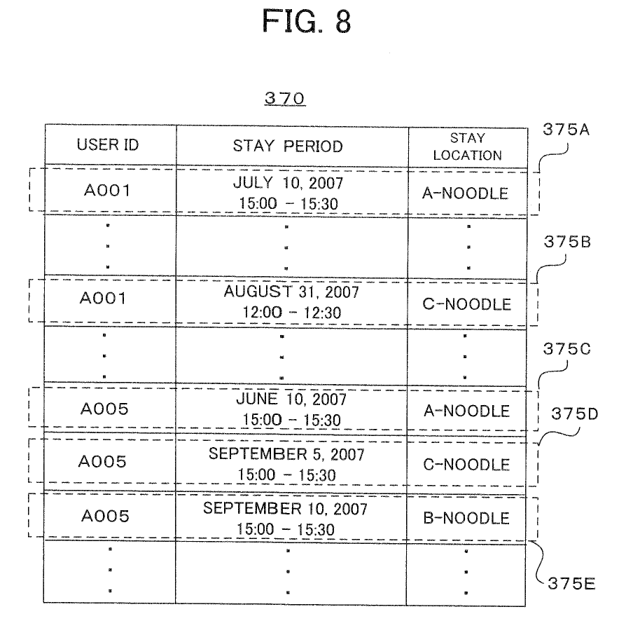

First, the stay area history information searching unit 416 accesses the stay area history information DB 370 at a predetermined timing, and obtains the stay area history information 375. FIG. 8 shows an example of the searched stay area history information 375. The stay location connection information generating unit 417 generates the link 450, which is a pair of the stay facilities of the same category for each of the same user IDs by the unit of category. In the example of FIG. 8, according to the stay area history information 375A and the stay area history information 375B, it is understood that the same user ID “A001” stays at an A-noodle restaurant and a C-noodle restaurant. The stay location connection information generating unit 417 generates the link between the A-noodle restaurant and the C-noodle restaurant, and prescribes the link weight information 451 as “1”. Then, the stay location connection information generating unit 417 generates the link information 515 including the link 511 being the above link 450 and the link weight 512 being the link weight information 451. Also, according to the stay area history information 375C, the stay area history information 375D and the stay area history information 375E, it is understood that the same user ID “A005” stays at the A-noodle restaurant, a B-noodle restaurant and the C-noodle restaurant. Therefore, the stay location connection information generating unit 417 generates the link 450 between the A-noodle restaurant and the B-noodle restaurant and the link 450 between the B-noodle restaurant and the C-noodle restaurant, and prescribes each of the link weight information 451 as “1”. Then, the stay location connection information generating unit 417 generates the link information 515 with using the above link 450 and the link weight information 451. As for the link 450 between the A-noodle restaurant and the C-noodle restaurant, the link information 515 between the A-noodle restaurant and the C-noodle restaurant exists. Thus, the stay location connection information generating unit 417 increases the link weight 512 of the link information 515 between the A-noodle restaurant and the C-noodle restaurant by “1”.

In this manner, the stay location connection information generating unit 417 generates the link information 515 with using the stay area history information 375.

Then, the stay location connection information generating unit 417 calculates the number of people staying at each facility, and generates the facility stay number information 525. Concretely, the stay location connection information generating unit 417 calculates the facility stay number 460 being the number of people staying at each facility with using the searched stay area history information 375. Then, the stay location connection information generating unit 417 generates the facility stay number information 525 including the facility name 521 being the stay location 373 of the stay area history information 375 and the staying people number 522 being the facility stay number 460 corresponding to the above stay location 373.

The stay location connection information generating unit 417 calculates the link connection number 470 as to the stay facility included in the link information 515, and generates the link connection number information 535 with using the link connection number 470. Concretely, the stay location connection information generating unit 417 calculates the link connection number 470 by calculating the number of link information 515 of each facility from the link information 515 generated with using the stay area history information 375. For example, in such a case that the link information 515 between the A-noodle restaurant and the B-noodle restaurant, the link information 515 between the A-noodle restaurant and the C-noodle restaurant and the link information 515 between the A-noodle restaurant and a ID-noodle restaurant exist, which means that three pieces of link information 515 of the A-noodle restaurant exist, the stay location connection information generating unit 417 prescribes the link connection number 470 of the A-noodle restaurant as “3”. Then, the stay location connection information generating unit 417 generates the link connection number information 535 including the facility name 531 being the facility name in the link 511 of the link information 515 and the link connection number 532 being the link connection number 470 corresponding to the above facility name.

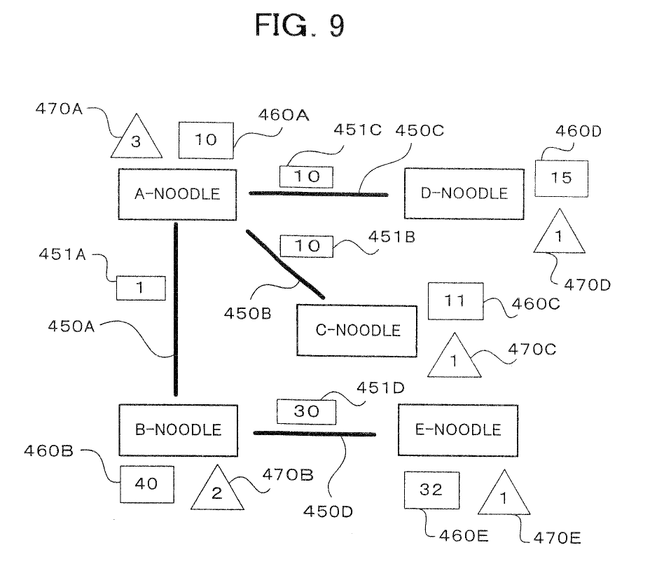

FIG. 9 shows a diagram conceptually showing a result of generating the link information 515, the facility stay number information 525 and the link connection number information 535 in the above-mentioned manner.

In FIG. 9, the link 450 means the link of each of the noodle restaurants. For example, a link 450A means the link between the A-noodle restaurant and the B-noodle restaurant. The link weight information 451 shows the link weight. For example, link weight information 451A shows that the weight of the link 450A is 1. The facility stay number 460 means the stay number in each facility. For example, a facility stay number 460A shows that the stay number in the A-noodle restaurant is 10. The link connection number 470 shows the number of links connected by each facility. For example, a link connection number 470A shows that the number of links connected to the A-noodle restaurant is 3.

In the case of FIG. 9, the largest facility stay number 460 is the B-noodle restaurant in the A to E-noodle restaurants. The link weight information 451A as to the link 450 between the A-noodle restaurant and the B-noodle restaurant is “1”, and link weight information 451B as to the link 450 between the A-noodle restaurant and the C-noodle restaurant is “10”. Thus, when the information of the noodle restaurants is requested from the information supply requesting device 500 staying at only the A-noodle restaurant, the stay location connection information register server 400 determines that it is better to recommend the C-noodle restaurant than the B-noodle restaurant.

In this manner, the stay location connection information register server 400 generates the link information 515, which can make it possible to supply the search result in the order of user preference, not in the order of popularity.

The stay location connection information register unit 418 registers the link information 515 to the link information DB 510. Then, the stay location connection information register unit 418 registers the facility stay number information 525 to the facility stay number information DB 520. Further, the stay location connection information register unit 418 registers the link connection number information 535 to the link connection number information DB 530.

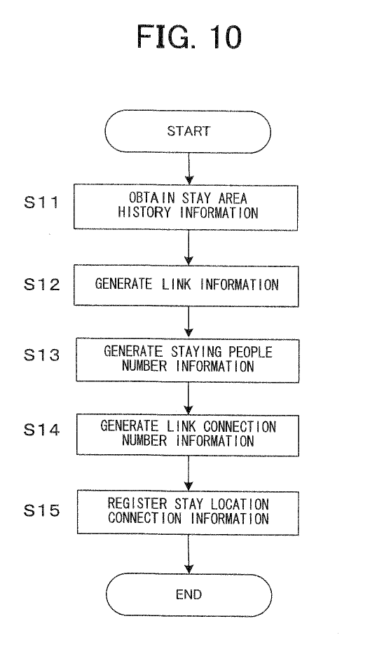

Now, a description will be given of a procedure of the stay location connection information register process with reference to a flow chart shown in FIG. 10. This process is realized in such a manner that the control unit 401 in the stay location connection information register server 400 executes a predetermined program.

First, the stay area history information searching unit 416 obtains the stay area history information 375 from the stay area history information DB 370 (step S11). Then, the stay location connection information generating unit 417 generates the link 450 and the link weight information 451 with using the stay area history information 375 obtained by the stay area history information searching unit 416, and generates the link information 515 including the link 450 and the link weight information 451 (step S12). Then, the stay location connection information generating unit 417 generates the facility stay number information 525 for each of the stay facility with using the stay area history information 375 obtained in step S11 (step S13). Then, the stay location connection information generating unit 417 generates the link connection number information 535 with using the generated link information 515 (step S14).

The stay location connection information register unit 418 registers the link information 515 generated by the stay location connection information generating unit 417 to the link information DB 510, and registers the facility stay number information 525 to the facility stay number information DB 520. Further, the stay location connection information register unit 418 registers the link connection number information 535 to the link connection number information DB 530 (step S15). Then, the stay location connection information register process ends.

### [Recommendation Information Supplying Process]

Next, a description will be given of a recommendation information supplying process. The recommendation information supplying process in this embodiment is a process which generates the recommendation information 754 with using the stay area history information 370 corresponding to the above user ID 710 and the stay location connection information to supply the recommendation information 754 after obtaining the user ID 710 corresponding to the information supply requesting device 500 and the category subjected to the request from the information supply requesting device 500 and receiving the supply request of the recommendation information 754.

First, when the information supply request receiving unit 420 obtains the user ID 371 and the category subjected to searching from the information supply requesting device 500, the stay area history information detecting unit 416 searches the stay area history information 375 including the user ID 371 being the above user ID and including the category correspondent to the stay location 373 corresponding to the category subjected to searching.

The recommendation information generating unit 421 accesses the category DB 360, and obtains the facility name 362 corresponding to the same category name 361 as the category subjected to searching. Then, the recommendation information generating unit 421 obtains the link information 515 corresponding to the obtained facility name 362 from the link information DB 510, and obtains the facility stay number information 525 corresponding to the obtained facility name 362 from the facility stay number information DB 520. Further, the recommendation information generating unit 421 obtains the link information 535 corresponding to the obtained facility name 362 from the link connection number information DB 530.

Then, in accordance with a standard which will be described below, the recommendation information generating unit 421 determines the priority of the information to be supplied with using the searched stay area history information 375 and the searched stay location connection information, and generates the recommendation information 754.

(Policy 1) Priority is given to the facility including the link 511 of the link information 515 of the stay location 373 of the searched stay area history information 375.

(Policy 2) Priority is given to the facility with the larger link weight 512 in such a case that there exist plural facilities including the link 511 of the link information 515 of the stay location 373 of the searched stay area history information 375.

(Policy 3) Priority is given to the facility with the larger staying people number 522 of the facility stay number information 525 in such a case that the plural facilities including the link 511 of the link information 515 of the stay location 373 of the searched stay area history information 375 have the same link weight 512.

(Policy 4) Priority is given to the facility with the larger link connection number 532 of the link connection number information 535 in such a case that the dominance decision cannot be made on the basis of the above-mentioned (Policy 1) to (Policy 3)

The recommendation information supplying unit 422 transmits the recommendation information 754 generated by the above recommendation information generating unit 421 to the information supply requesting device 500 via the transmitting/receiving unit 402.

In this manner, the stay location connection information register server 400 searches the stay area history information 375 of the user ID 710 obtained from the information supply requesting device 500, and searches the link information 515, the facility stay number information 525 and the link connection number information 535, as to the category subjected to searching.

In accordance with the above-mentioned (Policy 1) to (Policy 4), the stay location connection information register server 400 generates the recommendation information 754 as to the stay location 373 of the stay area history information 375 of the information supply requesting device 500. Thereby, since the stay location connection information register server 400 preferentially supplies the facility information associated with the facility at which the information supply requesting device 500 stayed in the past, it becomes possible to supply the information useful to the information supply requesting device 500 in comparison with a case of supplying the facility search result only in the order of popularity.

Additionally, since the stay location connection information register server 400 associates the link weight 512 with the link information 515 and registers the facility stay number information 525 and the link connection number information 535, even when the plural links 511 of the predetermined facility exist, the dominance can be determined.

The stay location connection information register server 400 generates the link information 515 in accordance with the categories. Thereby, the stay location connection information register server 400 can define the correspondent relation between the facilities by the unit of category.

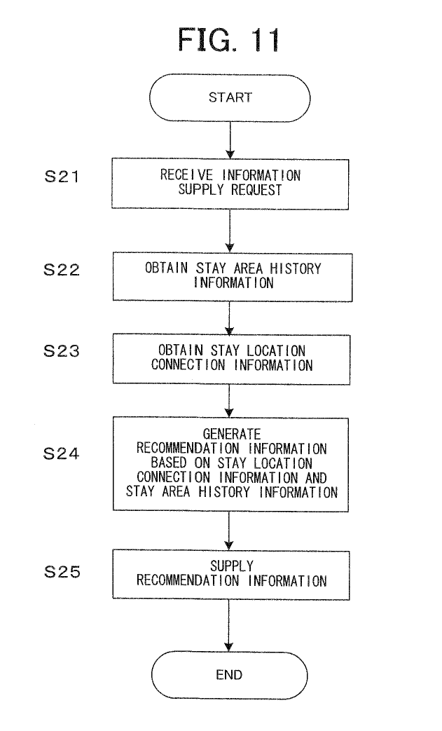

A description will be given of a procedure of the recommendation information supplying process with reference to a flow chart shown in FIG. 11, hereinafter. When the control unit 401 in the stay location connection information register server 400 executes a program prepared in advance, this process is realized.

First, when the information supply request receiving unit 420 receives the supply request of the recommendation information 754 from the information supply requesting device 500 with the user ID 710 (step S21), the stay area history information searching unit 416 obtains the stay area history information 375 corresponding to the above user ID 710 (step S22). Then, the stay location connection information searching unit 419 searches the link information 515, the facility stay number information 525 and the link connection number information 535 (step S23), corresponding to the facility as to the category subjected to searching. In accordance with the above-mentioned policies, the recommendation information generating unit 421 determines the priority to generate the recommendation information 754 with using the searched stay area history information 375 and the searched stay location connection information (step S24). The recommendation information supplying unit 422 supplies the recommendation information to the information supply requesting device 500 (step S25), and the recommendation information supplying process ends.

As described above, the stay location connection information register server 400 includes the history information retaining unit which includes the user information and the stay location information; the history information searching unit which searches the history information; the stay location connection information generating unit which generates the stay location connection information including the link information of the stay location by the unit of the user information with using the history information searched by the history information searching unit; and stay location connection information register unit which register the stay location connection information.

Accordingly, since the stay location connection information register device generates the link information of the stay location with using the history information to register the link information, the stay location connection information register server 400 can define the correspondent relation between the stay locations. Thus, the stay location connection information register device can supply the search result based on the relation between the stay locations with using the above link information.

Additionally, when determining that the current position information supplying device 300 migrates within the predetermined range during the predetermined period, the stay information specifying unit 412 prescribes the position within the range as the stay position. Thereby, even though the current position information supplying device 300 stays at the predetermined facility without stopping, the stay location connection information register server 400 can specify that the above current position information supplying device 300 stays.

The stay facility specifying unit 413 searches the facility information 355 including the predetermined range of the facility position 351 including the stay position 720, from the facility information DB 350. Thereby, the stay location connection information register server 400 can specify the facility corresponding to the stay position.

Additionally, when the stay period 730 does not coincide with the stay area determination condition of the opening hours 353 of the facility information 355 and the facility stay standard time 354 of the facility corresponding to the stay position 720, the stay facility specifying unit 413 determines that the current position information supplying device 300 does not stay in the facility corresponding to the above facility information 355. Thereby, the stay location connection information register server 400 can avoid misrecognizing that the current position information supplying device 300 stays, when the current position information supplying device 300 merely stops.

Further, when the searched facility information 355 does not coincide with the stay area determination condition, the stay facility specifying unit 413 searches the facility corresponding to the stay position 720, again. Thereby, even when the user of the current position information supplying device 300 stays at the facility other than the facility nearest to the stay position 720, the stay location connection information register server 400 can specify the stay facility.

With using the stay area history information 375, the preference category information register unit 415 of the stay location connection information register server 400 calculates the number of categories corresponding to the stay area, and specifies the preference category to register the preference category information. Thereby, the stay location connection information register server 400 can retain the preference category information.

### Another Embodiment

Though the description was given of such a case that the stay information specifying unit 412 specifies the facility in the above embodiment, the present invention is not limited to this. Namely, the predetermined area including the stay position 720 may be determined as the stay area.

In the above embodiment, the description was given of the case that the stay facility specifying unit 413 determines whether or not the stay period 730 coincides with the stay area determination condition of the facility information 355 corresponding to the stay position 720. However, the present invention is not limited to this. Namely, the present invention may be set so that the stay facility specifying unit 413 does not execute the above determination.

In the above embodiment, the description was given of the case that the facility information DB 350 has only the single facility stay standard time 354, but the present invention is not limited to this. Namely, the facility information DB 350 may include the plural facility stay standard times 354. For example, in such a case that there are plural use manners of the facility, if the facility stay standard time corresponding to each of the use manners is defined, the stay location connection information register server 400 can specify the purpose of using the facility with reference to the period in which the current position information supplying device 300 stays.

In the above embodiment, the description was given of such a case that the facility information specifying unit 412 determines such a state that the positional information 712 of the present facility information 800 successively stays at the predetermined location or within the predetermined range during the predetermined period, as the stop state or the migration state. But the present invention is not limited to this. Namely, in such a case that there is the predetermined number of same positional information 712 in predetermined period, the facility information specifying unit 412 may determine this state as the stop state or the migration state at the location.

In the above embodiment, the description was given of the case of generating the recommendation information 475 with using the stay location connection information generated by the stay location connection information register server 400, but the present invention is not limited to this. Namely, the stay location connection information generated by another device may be retained, and the recommendation information 475 may be generated with using the stay location connection information.

In the above embodiment, the description was given of such a case that the stay location connection information register server 400 obtains the user ID 710 from the information supply requesting device 500 and generates the recommendation information 754 based on the stay area history information 375 corresponding to the user ID 710, but the present invention is not limited to this. Namely, the recommendation information 754 may be generated based on a predetermined facility name such as destination information from the information supply requesting device 500.

In the above embodiment, the description was given of the case of specifying the stay position based on the current position information 800 obtained from the current position information supplying device 300 and generating the stay area history information 375, but the present invention is not limited to this. Namely, the stay position may be specified from blog information, and the stay area history information 375 may be generated.

In the above embodiment, the description was given of the case of applying the current position information supplying device 300 to the navigation device, but the present invention is not limited to this. Namely, the current position information supplying device 300 may be applied to various kinds of devices having a GPS function. For example, the current position information supplying device 300 may be applied to a cell phone having the GPS function.

### INDUSTRIAL APPLICABILITY

This invention can be used for a device which associates the past stay facility.

1-9. (canceled)

10. A stay location connection information register device, comprising:
a history information retaining unit which retains history information including user information and stay location information;
a history information searching unit which searches the history information;
a stay location connection information generating unit which generates stay location connection information including link information of a link, which is a pair of stay locations corresponding to same user information, with using the history information searched by the history information searching unit; and
a stay location connection information register unit which registers the stay location connection information.

11. The stay location connection information register device according to claim 10, wherein the stay location connection information generating unit generates link weight information with using the history information retaining unit, and associates the link weight information with the link information.

12. The stay location connection information register device according to claim 10, further comprising a category information retaining unit which retains category information, wherein the stay location connection information generating unit generates the stay location connection information for each category.

13. The stay location connection information register device according to claim 10, wherein the stay location connection information generating unit generates stay number information of the stay location, and includes the stay number information in stay location connection information.

14. The stay location connection information register device according to claim 10, wherein the stay location connection information generating unit generates link connection number information of the stay location, and includes the link connection number information in stay location connection information.

15. The stay location connection information register device according to claim 10, further comprising:
a recommendation information supply request receiving unit which receives recommendation information supply request with user information of an information supply requesting device;
a stay location connection information searching unit which searches the stay location connection information;
a recommendation information generating unit which generates recommendation information with using the history information corresponding to the user information of the information supply requesting device and the stay location connection information; and
a recommendation information supplying unit which supplies the recommendation information to the information supply requesting device.

16. A stay location connection information register method, comprising:
a history information retaining process which retains history information including user information and stay location information;
a history information searching process which searches the history information;
a stay location connection information generating process which generates stay location connection information including link information of a link, which is a pair of stay locations corresponding to same user information, with using the history information searched by the history information searching process; and
a stay location connection information register process which registers the stay location connection information.

17. A computer program product in a computer-readable medium executed by a stay location connection information register device comprising a computer, making the computer function as:
a history information retaining unit which retains history information including user information and stay location information;
a history information searching unit which searches the history information;
a stay location connection information generating unit which generates stay location connection information including link information of a link, which is a pair of stay locations corresponding to same user information, with using the history information searched by the history information searching unit; and
a stay location connection information register unit which registers the stay location connection information.

18. A storage medium which stores a computer program product in a computer-readable medium executed by a stay location connection information register device comprising a computer, making the computer function as:
a history information retaining unit which retains history information including user information and stay location information;
a history information searching unit which searches the history information;
a stay location connection information generating unit which generates stay location connection information including link information of a link, which is a pair of stay locations corresponding to same user information, with using the history information searched by the history information searching unit; and
a stay location connection information register unit which registers the stay location connection information.
